(19) United States
(12) Patent Application Publication
(10) Pub. No.: US 2002/0145876 A1
(43) Pub. Date: Oct. 10, 2002

(54) Non-fragile work lamp

(76) Inventor: Jiann Her Juang, Taichung City (TW)

Correspondence Address: Keith Kline, PRO-TECHTOR INTERNATIONAL SERVICES, 20775 Norada Court, Saratoga, CA, 95070-3018, US

(21) Appl. No.: 09/827,483

(22) Filed: Apr. 6, 2001

(51) Int. Cl. F21V 15/00

(52) U.S. Cl. 362/378; 362/369; 362/250; 362/396; 362/398; 362/430

(57) ABSTRACT

A work lamp comprises a protective sleeve, a cap, and a lamp device received in the protective sleeve including two sockets and an auxiliary shell member all supported by a plurality of elastic members, thereby ensuring the work lamp to be non-fragile while operating.

### FIELD OF THE INVENTION

The present invention relates to work lamps and more particularly to a non-fragile work lamp with improved characteristics.

### BACKGROUND OF THE INVENTION

Conventionally, a work lamp is used in an environment where the lighting position is liable to change such as automobile repairing station. It is often found that the work lamp is collided with other object or fallen on the ground. However, most previous work lamps are fragile, thus causing inconvenience to workers. Therefore, improvement is desirable in order to overcome the above drawback of prior art.

### SUMMARY OF THE INVENTION

It is an object of the present invention to provide a non-fragile work lamp comprising: a protective sleeve; a lamp device received in the protective sleeve, the lamp device including a first base at one end, the first base including an on/off switch, a rear connection member for electrically connecting to a power source, and a first recess; a first socket in the first recess; a lamp having one end secured to the first socket; a plurality of first radial elastic members having one ends fixed on the surface of the first socket for preventing the first socket from contacting the inner wall of the first recess; a first axial elastic member having one end fixed on the rear side of the first socket; a second base at the other end projected beyond the protective sleeve the second base including a second recess; an auxiliary shell member in the second recess with the other end of the lamp secured thereto; a plurality of second radial elastic members having one ends fixed on the surface of the auxiliary shell member for preventing the auxiliary shell member from contacting the inner wall of the second recess; a second axial elastic member having one end fixed on the front side of the auxiliary shell member; an elongate half cylindrical member connected between the first and second bases for receiving the lamp; a second socket in the front of the auxiliary shell member for receiving a bulb; and a plurality of third radial elastic members having one ends fixed on the surface of the second socket for preventing the second socket from contacting the inner wall of the second recess; and a cap secured to the second base.

According to one aspect of the present invention, the rear connection member is a hose having a clamp or a magnet at the free end.

According to another aspect of the present invention, there is provided a battery case enclosing the rear connection member and being electrically connected to the rear connection member.

According to still another aspect of the present invention, the auxiliary shell member is formed of a heat resistant material.

The above and other objects, features and advantages of the present invention will become apparent from the following detailed description taken with the accompanying drawings.

### BRIEF DESCRIPTION OF THE DRAWINGS

FIG. 1 is an exploded view of a first preferred embodiment of work lamp according to the invention;

FIG. 2 is a sectional view of the assembled FIG. 1 work lamp;

FIG. 3 is a perspective view of a second preferred embodiment of work lamp according to the invention; and

FIG. 4 is a perspective view of a third preferred embodiment of work lamp according to the invention.

### DETAILED DESCRIPTION OF THE PREFERRED EMBODIMENTS

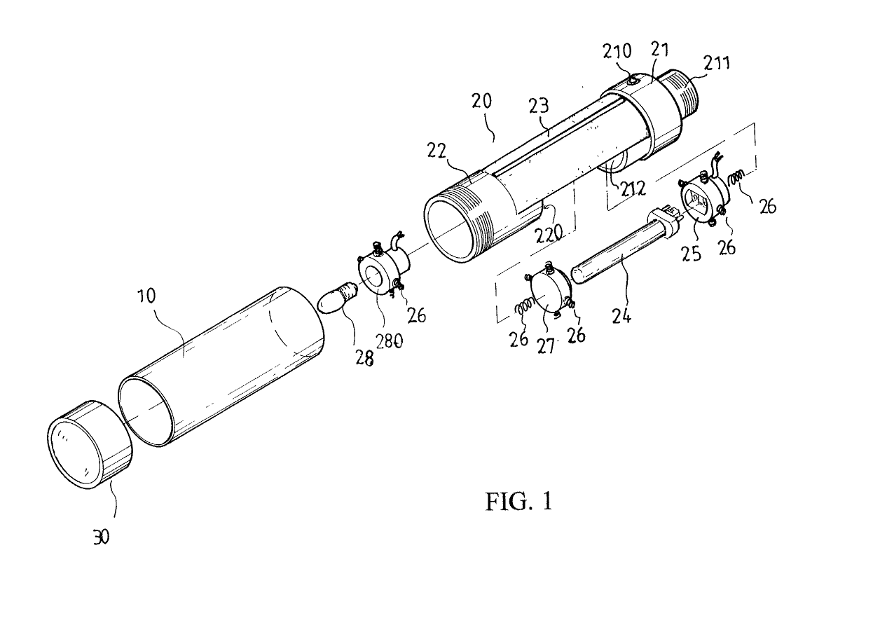

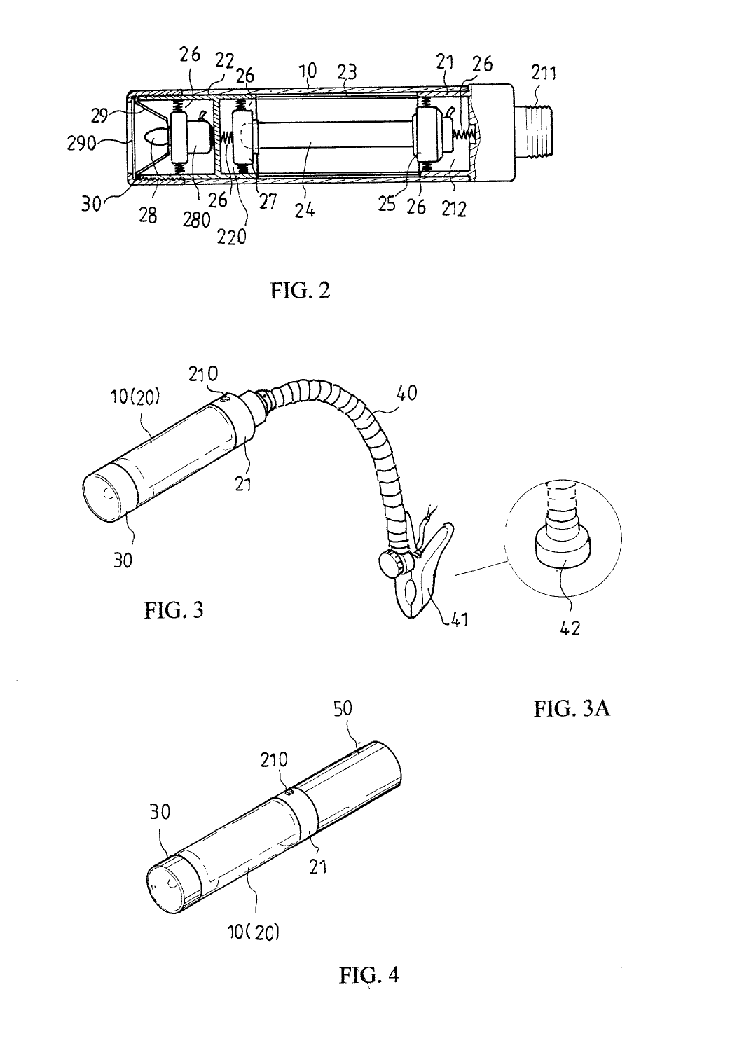

Referring to FIGS. 1 and 2, there is shown a work lamp constructed in accordance with the invention comprising a protective sleeve 10 and a lamp device 20 received in the protective sleeve 10. Lamp device 20 comprises a first base 21 at one end, a second base 22 at the other end, and an elongate half cylindrical member 23 connected between the first and second bases 21 and 22. First base 21 comprises an on/off switch 210 on the surface, a threaded rod 211 projected rearward for electrically connecting to a power source and a first recess 212. A lamp 24 is secured to first socket 25. A plurality of radial elastic members (e.g., spring) 26 have one ends fixed on the surface of first socket 25 for preventing first socket 25 from contacting the inner wall of first recess 212. An axial elastic member (e.g., spring) 26 has one end fixed on the rear side of first socket 25. Second base 22 comprises a second recess 220. An auxiliary shell member 27 is provided in second recess 220. The front end of lamp 24 is inserted in and secured to auxiliary shell member 27. Auxiliary shell member 27 is formed of heat resistant material such as bakelite. Similarly, a plurality of radial elastic members (e.g., spring) 26 have one ends fixed on the surface of auxiliary shell member 27 for preventing auxiliary shell member 27 from contacting the inner wall of second recess 220. An axial elastic member (e.g., spring) 26 has one end fixed on the front side of auxiliary shell member 27. Lamp 24 is provided in the elongate half cylindrical member 23. The front end of second base 22 is projected beyond protective sleeve 10. A second socket 280 is in the front of auxiliary shell member 27 for receiving a bulb 28. Also, a plurality of radial elastic members (e.g., spring) 26 having one ends fixed on the surface of second socket 28 for preventing second socket 28 from contacting the inner wall of second recess 220. A cone 29 is put on bulb 38. A piece of glass 290 is provided on the front end of cone 29. A cap 30 is threadedly secured to the front end of second base 22. The provision of first socket 25 and auxiliary shell member 27 can prevent lamp 24 from shaking in an operating state. Further, the provision of second socket 25 can prevent bulb 24 from shaking in the operating state. This ensures the work lamp of the invention to be non-fragile.

Referring to FIG. 3, there is shown a second preferred embodiment of work lamp according to the invention. The difference between first and second preferred embodiments is that the threaded rod 211 is replaced by a hose 40 having a clamp 41 (or a magnet 42) provided at the free end so as to fasten to a suitable work place.

Referring to FIG. 3, there is shown a third preferred embodiment of work lamp according to the invention. The difference between first and third preferred embodiments is that the threaded rod 211 is replaced by a cylindrical battery case 50 with a predetermined number of cells stored therein.

While the invention has been described by means of specific embodiments, numerous modifications and variations could be made thereto by those skilled in the art without departing from the scope and spirit of the invention set forth in the claims.

What is claimed is:

1. A work lamp comprising:
a protective sleeve;
a lamp device received in said protective sleeve, said lamp device including a first base at one end, said first base including an on/off switch, a projected rear connection member for electrically connecting to a power source, and a first recess; a first socket in said first recess; a lamp having one end secured to said first socket; a plurality of first radial elastic members having one ends fixed on said surface of said first socket for preventing said first socket from contacting said inner wall of said first recess; a first axial elastic member having one end fixed on said rear side of said first socket; a second base at said other end projected beyond said protective sleeve said second base including a second recess; an auxiliary shell member in said second recess with said other end of said lamp secured thereto; a plurality of second radial elastic members having one ends fixed on said surface of said auxiliary shell member for preventing said auxiliary shell member from contacting said inner wall of said second recess; a second axial elastic member having one end fixed on said front side of said auxiliary shell member; an elongate half cylindrical member connected between said first and second bases for receiving said lamp; a second socket in said front of said auxiliary shell member for receiving a bulb; and a plurality of third radial elastic members having one ends fixed on said surface of said second socket for preventing said second socket from contacting said inner wall of said second recess; and
a cap secured to said second base.

2. The non-fragile work lamp of claim 1, wherein said rear connection member is a hose having a clamp or a magnet at said free end.

3. The non-fragile work lamp of claim 1, further comprising a battery case enclosing said rear connection member and being electrically connected to said rear connection member.

4. The non-fragile work lamp of claim 1, wherein said auxiliary shell member is formed of a heat resistant material.
